(19) United States
(12) Patent Application Publication
(10) Pub. No.: US 2010/0242264 A1
(43) Pub. Date: Sep. 30, 2010

(54) Polar ordinate chamber

(76) Inventor: Edward Milton McWhorter, Citrus Heights, CA (US)

Correspondence Address: Edward M. McWhorter, 6931 Greenbrook Circle, Citrus Heights, CA, 95621, US

(21) Appl. No.: 12/286,888

(22) Filed: Oct. 3, 2008

(51) Int. Cl. H01F 7/06

(52) U.S. Cl. 29/605

(57) ABSTRACT

The invention is an electrical wire conductor having a plurality of double looped coils comprising a smaller inner loop, within a larger outer loop. The said small and large loops are connected in series alternately in a circular pattern upon a planar surface and are positioned about a central coordinate axis forming an electrical coil inductive winding. The said planar surface of the said inductive winding may be altered to form the same said inductive winding on a conical surface which displaces the interceding magnetic field of the said small loops to one side of the winding major coordinate axis forming a vectored propelling force as well as providing an aligning orientation of the major axis of free radicals and other charged ions and particles along the Polar Ordinate Chamber common axis. The invention is used for the chemical synthesis and production of acetylene and cyanamide from nitrogen and carbon dioxide streams scrubbed from coal fired furnace smoke stack flue gas. With some modification the invention is also prescribed for the deactivation and disposal of nuclear waste and for the intensification of laser beams.

### CROSS REFERENCES

Ref. 1 application Ser. No. 12/055,093 filed Dec. 26, 2007
Ref. 2 U.S. Pat. No. 7,381,378 B2 Jun. 3, 2008
Ref. 3 U.S. Pat. No. 6,653,007 Nov. 25, 2003
Ref. 4 application Ser. No. 11/287,096 filed Nov. 28, 2005
Ref. 5 U.S. Pat. No. 6,831,825 Dec. 14, 2004

### BACKGROUND OF THE INVENTION

The invention teaches a method of winding magnetic induction coils. An electrical wire conductor is formed as a plurality of double looped coils comprising a smaller loop formed within a larger loop, said loops being alternately connected in series and fixedly attached to a disc planar surface in a circular pattern around a central coordinate axis. In other intended uses the said double loop coil may be placed in linear relationship on a flat surface or upon a conical surface. The novelty of the invention is the additive ability of the gathered plurality of the said smaller loops to produce an electromagnetic actinic focus along the longitudinal tubular axis of the Polar Ordinate Chamber. The purpose of the present invention and its intended use of said electromagnetic actinic focus is for the commercial synthetic production of acetylene and cyanamide from coal fired furnace flue gas. The said actinic focus concentrates electromagnetic lines of force emanating from the said smaller loops in a manner similar to an optical prismatic lens. The said electromagnetic lines of force act as an aligning filter mechanism reacting physically against the open bonds of dissociated molecular and atomic free radicals and electrostatically with charged ions within the flowing fluid media within the tubular structure of the present invention. The said electromotive and electrostatic forces help to align and to justify the said opened bonds of the said media flow alignment along a common longitudinal axis of the said tubular structure of the invention. Justification of the said open bonds of the reactive substance of the said media decreases the random scatter of the said open bonds of said free radicals and charged ions within said flowing media of copending Ref. 1 along a common axis required to assure continuity of selected replication of intended chemical reaction and increase the production yield of any given commercial product substance being produced within said Polar Ordinate Chamber.

Electrons are accelerated in the outer larger loop and are decelerated in the inner smaller loop of the said double loop winding. Because of the constant acceleration and deceleration along the path of travel of electrons within each loop of the said double loop winding is not isochronal about their respective locus's of curvature such that their velocities constantly change as a function of the relative cosine distribution of the resistivities of the wire conductor with respect to changes in said conductor surface curvature. The changes in said resistivity, though very slight are sufficient to effect the actinic phenomena associated with electrons travelling at very high velocity (vₑ). Electrons within a conductor are in thermal equilibrium with their surroundings and therefore their relative velocities within each loop of the said double loop winding can be determined according to kinetic theory where a=½ mvₑ², although the electron mass (mₑ) is only 1/1835 that of a hydrogen ion their velocity (vₑ=7.88×10 cm/sec) and its change in momentum during deceleration in the said inner small loop is sufficient to result in a distribution of quanta radiation particle debris at the bottom curvature of the said inner small loop producing the said actinic focus.

The relative size and trace curvature of the inner and outer wire loops are not specifically defined except in a general manner and this generalization forms the basis of the broader claims presented and is considered a general case applicable to all double looped coils fabricated in series induction windings.

The most efficient configuration of the double loop induction winding is that formed as a modified single node epicycle. The single node epicycle may be formed in two ways. It may be formed as a planar locus of a fixed point on a given circle FIG. 1 which rolls on a circle of equal diameter as shown in FIG. 2 forming a cardioid or it may be formed as a cardioid limacon of Pascal FIG. 5 as the local point on a line at a fixed distance from the intersection of a pivoting line about a point on a single fixed circle as shown in FIG. 4. Each of the said two ways of developing the single mode epicycle as shown in previous FIG. 2 and FIG. 6 forming the special case of the cardioid. When the length of the radius of gyration of each method of cardioid formation of FIG. 2 and FIG. 6 is changed and the same turning angular velocity is maintained the locus trace of each said method of cardioid formation forms a small loop at the single nodal point of each said locus as respectively shown in FIG. 3 and FIG. 5. The smaller inner loop formation of each system shown in FIG. 3 and FIG. 5 results from the changes in the length of the radius of gyration of each system. In FIG. 3 the radius of gyration is increased while the angular velocity remains the same. In FIG. 5 the radius of gyration is decreased while the angular velocity remains the same. In FIG. 3 the size of the smaller inner loop increases with the increase of the radius of gyration forming the boundary of the outer larger loop. In FIG. 5 the size of the smaller inner loop increases with a decrease in the radius of gyration forming the outer larger diameter loop. Both types of said small loop coil formation are considered special cases of the claimed general case as previously stated. There is, however, a comparative specific boundary dimensional restriction noted in the cycloidal trace of each type of planar generation. The length of the intervening distance, dimension (a), between the bottom of the smaller loop to the bottom of the larger loop as shown in FIGS. 1, 2, and 3 are a defining feature of each type of trace generation. In the epicycle two circle generation method of generation the dimension (a) is always the same regardless of the ancillary radius a shown in FIG. 3. In the Pascal single circle method of trace generation the said intervening distance between the bottom of the inner smaller loop and the outer larger loop has a maximum limit of radius of gyration equal to (b) and this said intervening distance can be decreased to its smallest limit (m+n=b) and finds particular use in the smaller diameters in laser applications and in hypersonic high sustained altitude propulsion and in the deactivation of nuclear waste.

The said two circle method of trace generation is useful in the control of electrical current circuits and chemical synthesis, and in hypersonic gaseous stream propulsion. The said Pascal single circle method of double loop trace formation is useful in laser beam control and in the deactivation of radioactive waste. Both the said two circle manner of trace generation, and Pascal single circle method of trace generation of two loop induction windings are considered as special cases of the claimed general case.

### SUMMARY OF THE INVENTION

From a single wire conductor a plurality of small loops are alternately formed inside larger loops in electrical series connection to configure a multicoil magnetic induction winding. The said winding comprising discrete sets of said double loop coils evenly distributed and perpendicularly positioned as planar circular rows of series connected discs about the longitudinal axis of a tubular chemical reaction chamber. High electron speeds are generated in the said outer larger wire loop where metal resistivity and hyperbolic momentum turning losses are low. Electron compaction occurs in the downstream half of the inner smaller loop resulting in heating and the loss of other photonic particulate matter which is directed as a focussed magnetic force along the said tubular chemical reaction chamber axis.

The radiant field of electron momentum loss in the said small loop coil is the perpendicular directing force of electromagnetic and electrostatic alignment of free radicals and charged ions flowing along the longitudinal axis of the said cylindrical chemical reaction chamber which is used for the fixation of nitrogen atoms to carbon atoms of carbon dioxide in the formation of cyanamide.

It is also an object of the invention to compliment the polymerization of acetylene production in the electrochemical process described in Ref. 1.

It is another object of the invention to manufacture cyanamide and its associated synthesized products from carbon dioxide and nitrogen removed from coal fired furnace flue gas as described in Ref. 2.

It is yet another object of the invention to produce potassium nitrate fertilizers and also sodium nitrates from spent electrolytic fuels described in Ref. 3.

It is still another object of the invention to produce a small high frequency double loop induction coil winding by the Pascal method suitable for densification of laser beams and for the deactivation of nuclear waste.

And continuing further, it is yet another object of the invention to reconfigure the planar orientation of the said double loop induction coil disc winding surface to form a conical surface necessary to produce an accumulated additive impulse from the alignment of a plurality of said conical cones to provide a strong high velocity vectored propulsive force along the longitudinal axis of the said Polar Ordinate Chamber to be used for extreme altitude assisted hypersonic propulsion.

It is another object of the invention to supplement the thermal heating required in the fixation of nitrogen to carbon by the subsidiary method described in Ref. 5.

### BRIEF DESCRIPTION OF THE DRAWINGS

Twelve drawing figures are presented. Drawings FIG. 1 through FIG. 6 are used to simplify the Background discussion and graphically illustrate the mathematical polar coordinate orientation of the electrical circuit double loop traces of the magnetic induction coil windings about their individual locus's relative to the directed actinic focus toward the longitudinal axes of the tubular structure of the Polar Ordinate Chamber of the invention. Drawings FIG. 7 through FIG. 12 are used to illustrate the construction and assembly of the invention in the Detailed Description of the Invention.

FIG. 1 Double circle epicycloidal generation circle elements.

FIG. 2 Double circle cardioid generation.

FIG. 3 Double circle, double loop generation of extended ancillary radius of gyration shown as a dimensioned radius arm that augments the radius of diameter b.

FIG. 4 Pascal method of generating the locus of a double loop coil trace using a line and a circle where (m=n) and (m+n=b).

FIG. 5 Pascals double loop coil trace (m<b).

FIG. 6 Pascals generated cardioid (m>b).

FIG. 7 Simplified double loop coil electrical conductor winding

FIG. 8 Double loop coil electrical conductor windings connected in series in a linear winding.

FIG. 9 Double loop oil electrical conductor winding positioned in a circular pattern about the cavity of the Polar Ordinate Chamber. For clarity the first two double loops are shown with a dielectric covering—the remaining winding pattern is indicated as line traces.

FIG. 10 is a cross-section of a single double loop coil of the winding shown in FIG. 9. It is used to describe the electronic mechanism that is responsible for the generation of the actinic polarization field comprising the novel features of the invention.

FIG. 11 shows the winding of FIG. 9 commercially encased and mounted on the Polar Ordinate Chamber tube shown in section.

FIG. 12 shows the assembled Polar Ordinate Chamber in partial cross-section.

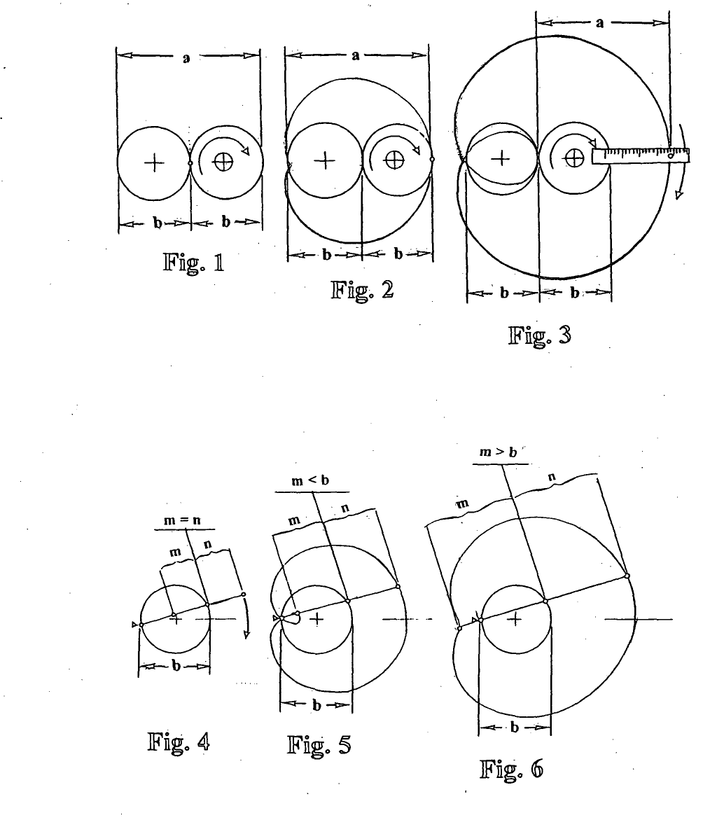

### DETAILED DESCRIPTION OF THE INVENTION

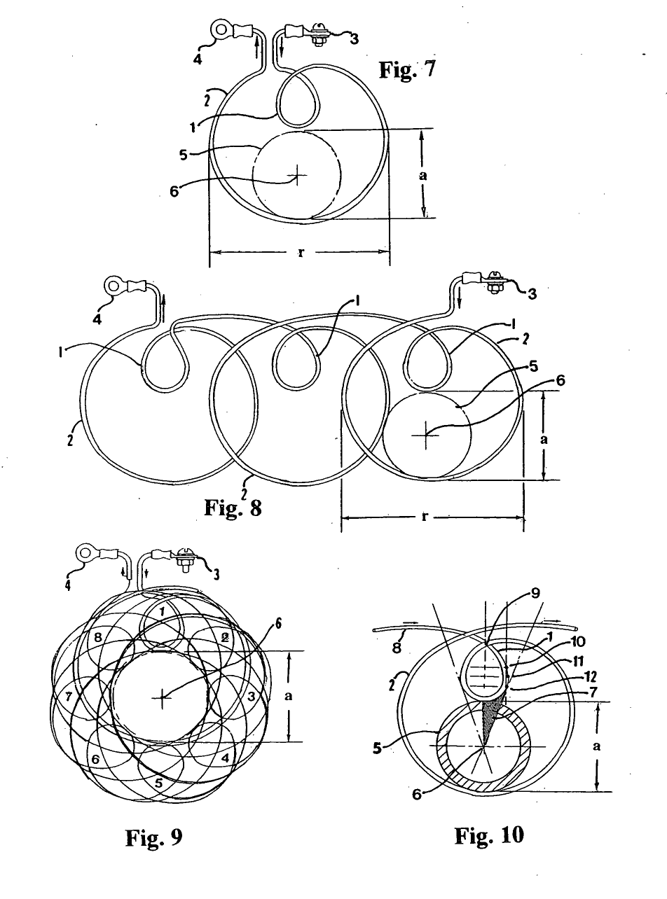

The invention is a double loop electrical coil comprising a small loop 1 within a larger loop 2 as shown in FIG. 7. An inlet electrical connector 3 and an outlet electrical connector 4 are shown in FIG. 7 to indicate the direction of direct current (dc) flow, however in other applications the coil can also fluctuate in a high frequency alternate current (ac) circuit. Dimension (a), indicates the outside diameter of the said Polar Ordinate Chamber tube 5. The longitudinal center of said Polar Ordinate Chamber is labelled 6, and its relative diameter designated dimension (a). In the 2 circle method of generating the single node epicycle will be constant and the dimension (a) will always be the same as tube 6 diameter and this will remain constant regardless of the length of the radius of gyration of the ancillary arm shown in previous FIG. 3 as a dimensioned extension arm.

Turning now to FIG. 8. FIG. 8 shows three double oils connected in series in a row. The numbered elements of FIG. 8 are the same as those of FIG. 7. When connected in a row the winding has significance to laser beam intensification and deactivation of nuclear waste.

FIG. 9 shows eight double loop coils in series electrical connection comprising a winding and positioned in a planar circular pattern axial center 6.

Turning now to FIG. 10. FIG. 10 illustrates the relative electrical circuit features of the said small loop 1 pertinent to the evolutive development of the actinic field focus 7 at tube 5 longitudinal center 6. High speed electrons from the interconnection 8 with large loop 2 enter loop 1 at an angle of incidence at crossover point 9 and proceed to beginning slowing compaction point 10 and proceed to inflection point 11. The compaction at point 10 causes actinic heat and the electrons begin to slow resulting in the loss of momentum at tangent point 12 at which point quanta of actinic field focus 7 material begin to escape from the entry quadrant at the bottom of small loop 1. Whenever charged electrons are accelerated or change their speed or direction of motion they give out electromagnetic waves. The said electromagnetic waves penetrate chamber tube 5 causing a magnetic radiation field of the actinic field focus 7 shown as the shadowed triangular portion reaching to chamber tube 5 longitudinal center 6. A plurality of said actinic field focuses are distributed along the chamber tube 5 longitudinal center. The distributed amount of actinic field focus 7 generated by the said double loop coil increases proportionately with the number of coils within the winding. The higher prismatic density of magnetic lines of force of the said electromagnetic waves increases the prismatic coefficient and filter efficiency directed toward the scattered and mixed alignment of open end bonds of free radicals and charged ions entering chamber tube 5 from the tuyere source of Ref. 1. Following the momentum compaction and attendant heating and photonic material given off at the bottom of small loop 1 the electrons begin once more to accelerate and leave small loop 1 at a refractive angle at crossover point 9.

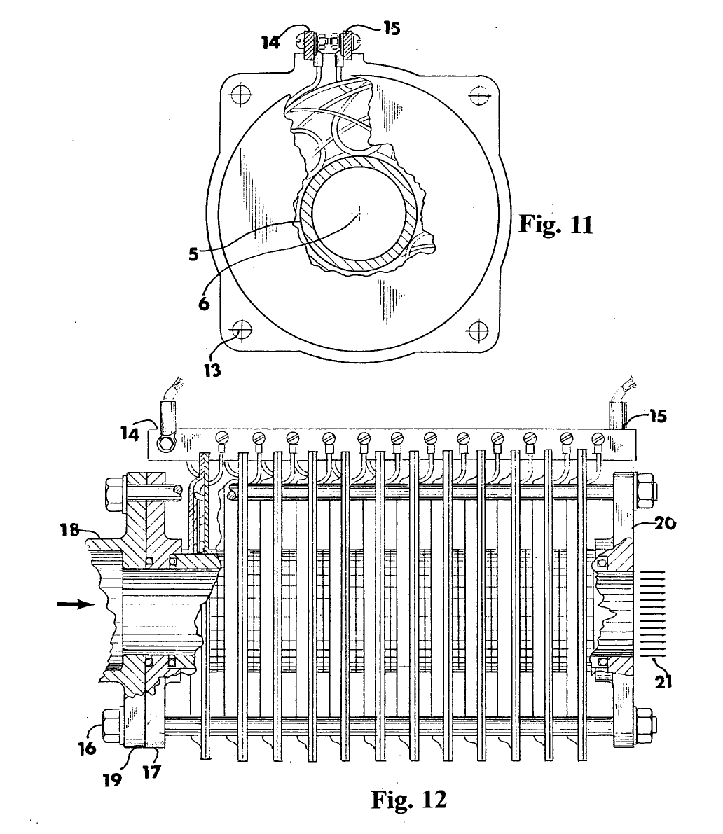

FIG. 11 is an encased circular coil series winding mounted on chamber tube 5 shown in cross-section. Bolt holes 13, shown in four places are used to mount each segment in parallel electric circuit to inlet electric bus bar 14 and outlet electric bus bar 15.

Turning to FIG. 12 which shows the assembly of twelve circular double loop windings of FIG. 11 mounted on chamber tube 5 and the method of clamping the assembly together with four bolts 16. The said assembly forward flange 17 is bolted to the heated nitrogen chamber 18 flange 19. The heated nitrogen flowing into chamber 18 is mixed with heated carbon dioxide from ionic stream from the tuyere chamber of Ref. 1. Both the heated nitrogen and heated carbon dioxide are from subsidiary heating source described in Ref. 4. The flow from chamber tube 5 flows past flange 20 into an ionic capacitor chamber of Ref. 5 as a base component product for further chemical synthesis.

### DESIGNATED AND NUMBERED ELEMENTS

### Background of the Invention

### Designated

a Sum of 2 circular diameters b (a=2b)
b Circular diameter
m=circular radius (2m=b)
n=ancillary radius (2n=b)
m<b double loop
m<6 cardioid

### Detailed Description of the Invention

### Numbered

| | |
|---|---|
| 1. | small loop |
| 2. | large loop |
| 3. | inlet electrical connector |
| 4. | outlet electrical connector |
| 5. | chamber tube |
| 6. | tube longitudinal center |
| 7. | actinic field focus |
| 8. | interconnection |
| 9. | crossover point |
| 10. | beginning compaction point |
| 11. | inflection point |
| 12. | tangent point |
| 13. | bolt holes |
| 14. | inlet bus bar |
| 15. | outlet bus bar |
| 16. | bolts |
| 17. | foreword flange |
| 18. | nitrogen chamber |
| 19. | nitrogen chamber flange |
| 20. | aft flange |
| 21. | commercial product stream |

What is claimed is:

1. A method of winding electromagnetic induction coils as a plurality of alternate large and small loop coils connected in series, said small loop coils positioned within said large loop coils, the speed of electrons moving in said large loop induction coil is accelerated because of the lower electrical resistivity of the more gradual rate of surface curvature of the said large loop coil and the same said electron speed is slowed by the higher electrical resistivity because of the greater rate of surface curvature of the said smaller loop coil, said higher electrical resistivity and the change of direction of electron flow at the inflection point of said small loop coil result in loss of electron stream momentum energy, said loss of momentum stream energy is accommodated by higher electron compaction reactions, said compaction reactions produce heat and photons as an electromagnetic field seen as an actinic focus at the lower end of the said smaller loop coil, said actinic focus being directed toward the center of the longitudinal axis of a Polar Coordinate Chamber.

2. The said large and small loop electromagnetic induction coil winding of claim 1 arranged in a planar circular pattern about said Polar Ordinate Chamber.

3. The said large and small loop electromagnetic induction coil winding of claim 1 arranged in a conical circular pattern about said Polar Ordinate Chamber.

4. The said large and small loop electromagnetic induction coil winding of claim 1 positioned in line parallel with the longitudinal axis of the said Polar Ordinate Chamber.
